(19) United States
(12) Patent Application Publication
(10) Pub. No.: US 2025/0192459 A1
(43) Pub. Date: Jun. 12, 2025

(54) PLUG CONNECTOR

(71) Applicant: ENNOVI ADVANCED ENGINEERING SOLUTIONS GERMANY GMBH, Heilbronn (DE)

(72) Inventors: Elison WANG, Suzhou City (CN); Gregory R. PRATT, Naperville, IL (US); Ralph SEMMELING, Meerssen (NL)

(21) Appl. No.: 18/844,685

(22) PCT Filed: Nov. 3, 2022
(86) PCT No.: PCT/EP2022/080697

§ 371 Date: Sep. 6, 2024

(30) Foreign Application Priority Data
Mar. 15, 2022 (DE) 10 2022 105 992.8

(51) Int. Cl. H01R 12/58; H01R 13/6597; H01R 43/20

(52) U.S. Cl. CPC H01R 12/585; H01R 13/6597; H01R 43/205

(57) ABSTRACT

The disclosure relates to a plug connector for direct electrical contact with a printed circuit board comprising at least one printed circuit board contact to be shielded, one shield body for shielding the at least one printed circuit board contact, and one contact carrier which is received in the shield body and has the at least one printed circuit board contact to be shielded. At least two press-in elements for pressing into the printed circuit board are arranged on a connection surface of the shield body facing toward the printed circuit board, and a mounting hole for mounting the contact carrier in the shield body is closed by means of a shield plate. At least one printed circuit board contact and the press-in elements have a common and/or identical plug-in direction. The disclosure also relates to a method for manufacturing the plug connector.

### RELATED APPLICATIONS

This application claims priority to and is a 35 U.S.C. § 371 national phase application of PCT/EP2022/080697, filed Nov. 3, 2022, and claims priority to German Patent Application No. 10 2022 105 992.8, filed Mar. 15, 2022, the entire contents of each of which are incorporated herein by reference in their entirety.

### FIELD

The disclosure relates to a plug connector for direct electrical contact with a printed circuit board comprising at least one printed circuit board contact to be shielded, one shield body for shielding the at least one printed circuit board contact, and one contact carrier which is received in the shield body and has the at least one printed circuit board contact to be shielded.

### BACKGROUND

Printed circuit board connectors are used to conduct currents within or between multiple printed circuit boards. It is first necessary to ensure sufficient shielding of the printed circuit board contacts, which improves electromagnetic compatibility and ensures interference-free signal transmission and signal processing.

In order to establish a permanent connection between the plug connector and the printed circuit board, solutions are known in the art in which the plug connector is fixed to the printed circuit board by means of a press-fit technique. A press-fit pin is pressed into a hole in a printed circuit board.

The drawback of the press-fit technique is that press-fit devices must be provided on the plug connector which ensure easy mounting of the plug connector on a printed circuit board. At the same time, sufficient shielding of the printed circuit board contacts is necessary, which makes manufacturing the plug connector complex.

### BRIEF SUMMARY

The present disclosure provides a plug connector for direct electrical contact with a printed circuit board which ensures shielding of the printed circuit board contacts, improves assembly on a printed circuit board, and optimizes the manufacture of the plug connector.

According to the disclosure, a plug connector for direct electrical contact with a printed circuit board is proposed which has at least one printed circuit board contact to be shielded, one shield body for shielding the at least one printed circuit board contact, and one contact carrier which is received in the shield body and has the at least one printed circuit board contact to be shielded. At least two press-in elements for pressing into the printed circuit board are arranged on a connection surface of the shield body facing toward the printed circuit board. Furthermore, a mounting hole for mounting the contact carrier in the shield body is closed by means of a shield plate, and the at least one printed circuit board contact and the press-in elements have a common, in particular identical, plug-in direction. The advantage of this is that the at least one printed circuit board contact in the contact carrier is optimally shielded by means of the shield body and can simultaneously be inserted by means of the mounting hole within the shield body and fixed by means of the shield plate, which also additionally shields the printed circuit board contact.

In an advantageous design variant, a provision is made that a mounting recess is formed on the connection surface which extends from a first axial end of the mounting hole at least partially along the connection surface and the mounting hole. In this way, the contact carrier with the printed circuit board contacts can be inserted from the side of the mounting hole, and the mounting recess prevents the printed circuit board contacts from striking the shield body and becoming bent.

Preferably, the plug connector is designed such that the at least one printed circuit board contact is angled, in particular angled substantially at a right angle or L-shaped. This makes an extension of the printed circuit board contact possible which deviates from the plug-in direction of the plug connector, which improves the mounting or connection of an electrical cable on or to the printed circuit board contact.

In one embodiment of the disclosure, a provision is made that the contact carrier is fixed in a form-fitting manner to the shield body, in particular to an axial end of the mounting recess, by means of the shield plate. The advantage of this is that the shield plate fixes the contact carrier on the one hand and shields it in the direction of the mounting hole on the other hand, thus ensuring complete shielding except in the direction of the connection surface.

Furthermore, an embodiment is favorable in which the at least one printed circuit board contact is embodied as a press-in contact. It is advantageous that, when the plug connector is fixed to the printed circuit board by means of the press-in elements, contact can be made to the printed circuit board at the same time by means of the press-in contact.

In another advantageous variant, the disclosure makes a provision that a first end and a second end of the at least one printed circuit board contact protrude from the contact carrier. In one design variant, the plug connector according to the disclosure is designed such that the contact carrier is received in the mounting hole in such a way that a first end of the at least one printed circuit board contact protrudes from the connection surface. It is also advantageous if the shield body has a receptacle with a receiving space for receiving a corresponding mating connector, and the at least one printed circuit board contact is arranged with the second end in the receiving space. Contacting of the plug connector is optimized in this manner.

In a preferred embodiment of the disclosure, the contact carrier is embodied in two parts. Furthermore, one variant is favorable in which the at least one printed circuit board contact is received in the contact carrier in such a way that a first portion of the printed circuit board contact is completely received in a first part of the contact carrier and a second portion of the printed circuit board contact is partially received in the first part. A second part of the contact carrier is fixed to an axial end of the first part in such a way that the second portion of the printed circuit board contact is completely surrounded by the first and second parts. Furthermore, in one exemplary embodiment, the second part of the contact carrier is fixed to the first part of the contact carrier with a snap-in connection. This improves the mounting of the at least one printed circuit board contact in the contact carrier.

In another advantageous design variant, a provision is made that the respective press-in element is fixed, in particular welded, in a receiving chamber of the shield body corresponding to the press-in element. The advantage of this is that the mounting position of the press-in elements on the shield body can be predetermined, and the assembly is optimized.

Preferably, the plug connector is designed such that the shield plate is fixed in a plate recess of the shield body which, in particular, is embodied as a groove in the mounting hole. The plate recess extends from the connection surface at least to the mounting hole. This enables the shield plate to be mounted from the side of the connection surface.

Also proposed according to the disclosure is a method for manufacturing a plug connector according to the preceding disclosure in which the contact carrier with the at least one printed circuit board contact is first inserted into the mounting hole along the mounting recess of the shield body. The shield plate is then inserted into the plate recess of the shield body. At least two press-in elements for pressing into receiving chambers of the shield body, mounted in a connection surface facing toward the printed circuit board, are mounted in the shield body, in particular by means of laser welding, and the press-in elements are oriented such that they have a common, in particular identical, plug-in direction with the at least one printed circuit board contact. The advantage of this is that the manufacturing of the plug connector is optimized.

In an advantageous embodiment, a provision is made that the contact carrier is pre-fixed after insertion in the shield body, in particular by means of a snap-in connection. This prevents the contact carrier from moving from the mounting position in the shield body during manufacturing.

Preferably, the manufacturing process is carried out in such a way that the shield plate is fixed after insertion into the plate recess, in particular by means of laser welding. This fixes the contact carrier in the shield body.

Furthermore, one design is advantageous in which the shield plate is manufactured by means of punching and a strip coating process before being inserted into the plate recess. It is also advantageous if the at least one printed circuit board contact is manufactured by means of punching and a strip coating process before being inserted into the contact carrier. This makes the automated manufacturing of the shield plate and printed circuit board contacts possible. The strip coating process is, in particular, a strip electroplating process.

In another advantageous variant, before the contact carrier is inserted into the mounting hole, the at least one printed circuit board contact is inserted into the first part of the contact carrier and then the contact carrier is assembled by means of a snap-in connection between the first part and the second part. This improves the mounting of the printed circuit board contact in the contact carrier.

In an advantageous exemplary embodiment of the disclosure, the contact carrier, in particular the first and the second part, is manufactured by injection molding before the insertion of the at least one printed circuit board contact. Furthermore, in an advantageous embodiment, a provision is made according to the disclosure that the press-in elements are fixed to the shield body by means of laser welding. In an advantageous embodiment, a provision is made that the press-in elements are manufactured by means of punching and a strip coating process before being mounted in the receiving chambers of the shield body. The strip coating process is, in particular, a strip electroplating process. Furthermore, one embodiment is advantageous in which the shield body is manufactured by means of a die-casting process before the contact carrier is inserted. The corresponding manufacturing processes of the individual components are especially favorable for an automated manufacturing process.

The features disclosed above can be combined as required, provided this is technically possible and they do not contradict one another.

### BRIEF DESCRIPTION OF THE DRAWINGS

Other advantageous refinements of the disclosure are characterized in the subclaims and/or depicted in greater detail below together with the description of the preferred embodiment of the disclosure with reference to the figures. Brief description of the drawings:

FIG. 1 shows a perspective view of a contact carrier with printed circuit board contacts of a plug connector; and

FIG. 2 shows a perspective view of the plug connector.

The figures are schematic examples. Same reference symbols in the figures indicate same functional and/or structural features.

### DETAILED DESCRIPTION

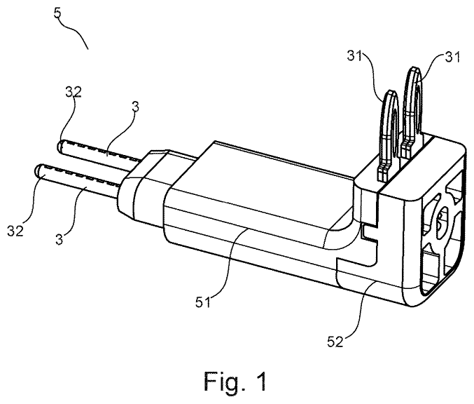

FIG. 1 shows a perspective view of a contact carrier 5 with printed circuit board contacts 3 of a plug connector 1 for direct electrical contact with a printed circuit board. The contact carrier 5 is embodied in two parts. Furthermore, two printed circuit board contacts 3 are received in the contact carrier 5 such that a first portion of the printed circuit board contact 3 is completely received in a first part 51 of the contact carrier 5. A second portion of the printed circuit board contact 3 is partially received in the first part 51 and a second part 52 of the contact carrier 5 is fixed to an axial end of the first part 51 such that the second portion of the printed circuit board contact 3 is completely surrounded by the first and second parts 51, 52 of the contact carrier 5. The second part 52 of the contact carrier 5 is fixed to the first part 51 of the contact carrier 5 with a snap-in connection.

The two printed circuit board contacts 3 are angled substantially at right angles or L-shaped. A first end 31 and a second end 32 of the two printed circuit board contacts 3 protrude from the contact carrier 5. In addition, the printed circuit board contacts 3, in particular the first end 31, are embodied as a press-in contact.

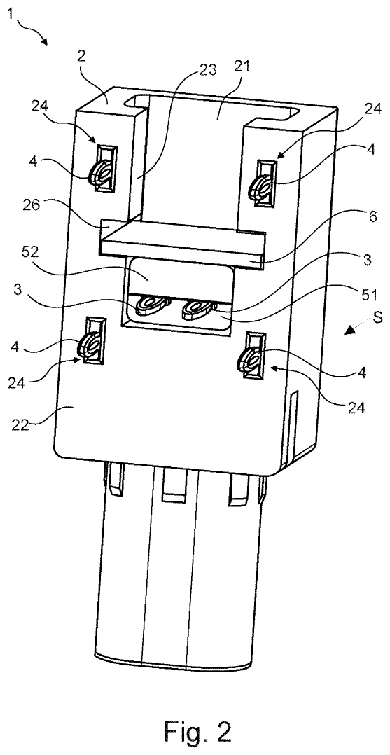

FIG. 2 shows a perspective view of a plug connector 1 for direct electrical contact with a printed circuit board comprising the contact carrier 5 shown in FIG. 1. Accordingly, the plug connector 1 comprises the two printed circuit board contacts 3 to be shielded, a shield body 2 for shielding the two printed circuit board contacts 3, and the contact carrier 5 which is received in the shield body 2 and has the printed circuit board contacts 3 to be shielded.

Four press-in elements 4 for pressing into the printed circuit board are arranged on a connection surface 22 of the shield body 1 facing toward the printed circuit board. Furthermore, a mounting hole 21 for mounting the contact carrier 5 in the shield body 2 is closed by means of a shield plate 6 and the at least one printed circuit board contact 3, and the press-in elements 4 have a common, in particular identical, plug-in direction S. A mounting recess 23 is formed on the connection surface 22 which extends from a first axial end of the mounting hole 21 partially along the connection surface 22 and the mounting hole 21. The mounting hole 21 is also embodied as a through hole. The contact carrier 5 is received in the mounting hole 5 in such a way that the first end 31 of the respective printed circuit board contact 3 protrudes from the connection surface 22.

In addition, the contact carrier 5 is fixed in a form-fitting manner to the shield body 2 at one axial end of the mounting recess 23 by means of the shield plate 6. The first part 51 is partially received in the mounting hole 21, and the contact housing 5 is fixed in a form-fitting manner to the shield body 2 such that the first part 51 rests on the axial end of the mounting recess 23 and the second part 52 rests on the shield plate 6. In addition, the first and second parts 51, 52 rest on side surfaces of the mounting recess 23.

The respective press-in element 4 is welded into a receiving chamber 24 of the shield body 2 corresponding to the press-in element 4. In addition, the shield plate 6 is fixed in a plate recess 26 of the shield body 2 which 23 is formed in the manner of a groove in the mounting hole 21. The plate recess 26 extends from the connection surface 22 to the mounting hole 21.

Furthermore, the shield body 2 has a receptacle 3 with a receiving space for receiving a corresponding mating connector, and the printed circuit board contacts 3 are arranged with the second end 32 in the receiving space.

The disclosure is not limited in its execution to the abovementioned preferred exemplary embodiments. Rather, a number of variants are conceivable which make use of the illustrated solution even in the form of fundamentally different embodiments.

1. A plug connector for direct electrical contact with a printed circuit board comprising at least one printed circuit board contact to be shielded, one shield body for shielding the at least one printed circuit board contact, and one contact carrier which is received in the shield body and has the at least one printed circuit board contact to be shielded,
wherein at least two press-in elements for pressing into the printed circuit board are arranged on a connection surface of the shield body facing toward the printed circuit board, and
wherein a mounting hole for mounting the contact carrier in the shield body is closed by means of a shield plate and the at least one printed circuit board contact and the press-in elements have a common and/or identical, plug-in direction.

2. The plug connector according to claim 1, wherein a mounting recess is formed on the connection surface which extends from a first axial end of the mounting hole at least partially along the connection surface and the mounting hole.

3. The plug connector according to claim 1, wherein the at least one printed circuit board contact is angled substantially at a right angle or L-shaped.

4. The plug connector according to claim 1, wherein the contact carrier is fixed in a form-fitting manner to the shield body at an axial end of the mounting recess, by way of the shield plate.

5. The plug connector according to claim 1, wherein the at least one printed circuit board contact is embodied as a press-in contact.

6. The plug connector according to claim 1, wherein a first end and a second end of the at least one printed circuit board contact protrude from the contact carrier.

7. The plug connector according to claim 6, wherein the contact carrier is received in the mounting hole such that a first end of the at least one printed circuit board contact protrudes from the connection surface.

8. The plug connector according to claim 6, wherein the shield body has a receptacle with a receiving space for receiving a corresponding mating connector, and the at least one printed circuit board contact is arranged with the second end in the receiving space.

9. The plug connector according to claim 1, wherein the contact carrier is embodied in two parts.

10. The plug connector according to claim 1, wherein the respective press-in element is fixed and/or welded in a receiving chamber of the shield body corresponding to the press-in element.

11. The plug connector according to claim 1, wherein the shield plate is fixed in a plate recess of the shield body which is formed in the manner of a groove in the mounting hole.

12. A method for manufacturing a plug connector according to claim 1, comprising the steps:
a. inserting the contact carrier with the at least one printed circuit board contact into the mounting hole along the mounting recess of the shield body,
b. inserting the shield plate into the plate recess of the shield body,
wherein at least two press-in elements for pressing into receiving chambers of the shield body, mounted in a connection surface facing toward the printed circuit board, are mounted in the shield body by laser welding, and the press-in elements are oriented such that they have a common, in particular identical, plug-in direction with the at least one printed circuit board contact.

13. The manufacturing method according to claim 12, wherein the contact carrier is pre-fixed after insertion in the shield body by a snap-in connection.

14. The manufacturing method according to claim 12, wherein the shield plate is fixed after insertion into the plate recess, in particular by laser welding.

15. The manufacturing method according to claim 12, wherein the shield plate is manufactured by punching and a strip coating process before insertion into the plate recess.

16. The manufacturing method according to claim 12, wherein, before the contact carrier is inserted into the mounting hole, the at least one printed circuit board contact is inserted into the first part of the contact carrier and then the contact carrier is assembled by means of a snap-in connection between the first part and the second part.

17. The manufacturing method according to claim 12, wherein the at least one printed circuit board contact is manufactured by punching and a strip coating process before being inserted into the contact carrier.

18. The manufacturing method according to claim 12, wherein the first and the second part of the contact carrier is manufactured by injection molding before the insertion of the at least one printed circuit board contact.

19. The manufacturing method according to claim 12, wherein the press-in elements are manufactured by punching and a strip coating process before being mounted in the receiving chambers of the shield body.

20. The manufacturing method according to claim 12, wherein the shield body is manufactured by a die-casting process before the insertion of the contact carrier.
